(19) United States
(12) Patent Application Publication
(10) Pub. No.: US 2010/0074303 A1
(43) Pub. Date: Mar. 25, 2010

(54) Wireless Communication Apparatus

(75) Inventor: Akio Tanaka, Tokyo (JP)

Correspondence Address: YOUNG & THOMPSON, 209 Madison Street, Suite 500, Alexandria, VA, 22314, US

(73) Assignee: NEC CORPORATION, Minato-ku, Tokyo (JP)

(21) Appl. No.: 12/514,415

(22) PCT Filed: Nov. 2, 2007
(86) PCT No.: PCT/JP2007/071424

§ 371 Date: May 11, 2009

(30) Foreign Application Priority Data
Nov. 10, 2006 (JP) 2006-305825

(51) Int. Cl. H04B 1/713

(52) U.S. Cl. 375/133; 375/E01.033

(57) ABSTRACT

A wireless communication apparatus comprises a local generator for generating a local signal having a frequency equal to the central frequency of the band group; a first down converter for down-converting a wireless signal in each of the bands into an IF signal; a hopping complex filter for removing an image signal in the frequency range of a band to pass therethrough, among down-converted signals, said hopping complex filter having filter characteristics changeable depending on the hopping between the bands; and a second down converter for converting an IF signal of a band which does not contain said central frequency into a baseband signal in a predetermined frequency range about a DC level.

### TECHNICAL FIELD

The present invention relates to a wireless communication apparatus for performing wireless communications while hopping fast between a plurality of bands each having an ultra-wide frequency range.

### BACKGROUND ART

In recent years, wireless communication apparatus are required to have a fast data transmission capability. For example, wireless LAN apparatus in compliance with IEEE 802.11a have a communication rate of 54 Mbps. Furthermore, UWB “Ultra Wide Band” has been formulated by IEEE 802.15.TG3a as a technology for achieving a higher communication rate of 480 Mbps.

Wireless communication apparatus for fast communications need to occupy a very wide frequency band according to Shannon's law. For example, a wireless communication apparatus according to UWB (hereinafter referred to “UWB wireless communication apparatus”) uses a frequency band from 3.1 GHz to 10.6 GHz. There have not been available thus far wireless communication apparatus which need a frequency band that is about three times the lower-limit frequency.

The basic operation of a UWB wireless communication apparatus is disclosed in U.S. published patent application No. 2004/0047285 (hereinafter referred to as “Patent document 1”), for example.

The UWB wireless communication apparatus has a plurality of bands each having a predetermined frequency range (e.g., 500 MHz) for wireless communications, as shown in FIG. 1(a), for example. The UWB wireless communication apparatus sends and receives user data (hereinafter referred to as “UWB signal”) in units of OFDM (Orthogonal Frequency Division Multiplexing) symbols f1 through f3 while hopping between the bands according to a predetermined sequence.

A receiver disclosed in Patent document 1 is base on the direct conversion principles for converting received RF (Radio Frequency) signals directly into baseband signals. The receiver generates a plurality of local signals corresponding to the radio frequencies of the respective bands in synchronism with the hopping process (FIG. 1(b)). The received RF signals are down-converted into baseband signals in the 500-MHz band by a mixer using the corresponding local signals. The baseband signals are then converted into digital signals by an A/D converter having a conversion rate of 500 Msps (Mega samples per second).

A transmitter disclosed in Patent document 1, which has a D/A converter having a conversion rate of 500 Msps, generates a plurality of local signals corresponding to the radio frequencies of the respective bands in synchronism with the hopping process, as with the receiver. Baseband signals to be transmitted are up-converted into RF signals by a mixer using the local signals of the corresponding frequencies.

Another UWB wireless communication apparatus according to the background art is disclosed in Japanese laid-open patent publication No. 2006-121439 (hereinafter referred to as “Patent document 2”). The disclosed UWB wireless communication apparatus has a configuration for sending and receiving a UWB signal which hops between bands, using local signals having fixed frequencies (FIG. 1(c)).

A receiver disclosed in Patent document 2 fast-ND converts IF (Intermediate Frequency) signals having a frequency range of 2112 MHz. In the UWB wireless communication apparatus, each band has a frequency range of 528 MHz, and the IF signals in three bands (first through third bands) are A/D-converted altogether. After being down-converted, the IF signals have a frequency range from −264 to +1320 MHz. The IF signal in the first band is present about a DC (Direct Current) level. The IF signal in the second band is present about 528 MHz, and the IF signal in the third band is present about 1056 MHz. Therefore, the ND-converted IF signals are down-converted again by digital signal processing.

The UWB wireless communication apparatus according to the background art which are disclosed in Patent document 1 and Patent document 2 suffer the following problems:

The first problem is that the scale of a circuit for generating the local signals and the power consumption thereof are large.

The receiver disclosed in Patent document 1 is required to generate local signals corresponding to radio frequencies to be hopped to within an interval of about 9.5 ns. Usually, a PLL (Phase Locked Loop) circuit is used to generate a plurality of frequency signals. The PLL circuit takes about several p seconds until it is locked at a desired frequency. Accordingly, for switching between the frequencies of local signals in several ns, it is necessary to combine local signal in respective bands with a number of SSB (Single Side Band amplitude modulation) mixers and frequency dividers. Therefore, the PLL circuit tends to have a very large circuit scale and consume a very large amount of electric power. The fast frequency hopping process described above has not been performed by the wireless communication apparatus according to the background art.

The configuration disclosed in Patent document 2 is also problematic in that its power consumption is large. According to Patent document 2, as described above, it is necessary to fast-ND-convert the IF signals having the frequency range of 2112 MHz. Therefore, it is necessary to increase bias currents in amplifiers and buffers for realizing fast switching operation, resulting in increased power consumption. The power consumption is also increased because parasitic capacitors that are present in the circuit are charged and discharged fast.

The second problem is that the UWB wireless communication apparatus produce spurious emissions.

According to Patent document 1, as described above, local signals of frequencies corresponding to the bands are generated by combining a plurality of types of frequency signals with mixers and frequencies. Consequently, frequency components that are integral multiples of the frequency signals to be combined tend to appear in the local signals. Particularly, though the SSB mixers need to have a large input amplitude in order to produce a large output amplitude, they tend to produce high harmonics due to the circuit nonlinearity if the input amplitude is increased.

In addition, local feedthrough whereby frequency components input to the SSB mixers directly appear at the output of the SSB mixers is also responsible for increased spurious emissions. This problem is caused because mixers as nonlinear devices are used to realize fast hopping, and has not been experienced by the wireless communication apparatus according to the background art.

The third problem is that it is difficult to remove an offset of a mixer or an amplifier. Even if an offset can be removed by an offset removing circuit, the offset removing circuit tends to have a large circuit scale (area) and consume a large amount of electric power.

The third problem is that the offset of a mixer (down converter) varies depending on hopping. A mixer that is used as a down converter gives rise to a phenomenon called self-mixing wherein a DC component (offset) is generated by multiplying local signals and signals of its own (local signals) that are introduced through an antenna into the mixer. Self-mixing is frequency-dependent such that the offset varies depending on the frequencies of the local signals. Since the frequencies of the local signals change fast in the UWB wireless communication apparatus, the offset also changes fast. This problem is also caused because of fast hopping, and has not been experienced by the wireless communication apparatus according to the background art.

The fourth problem is that it is difficult to remove a local leak from the mixers (up converters) of the transmitter. Even if a local leak can be removed by a local leak removing circuit, the local leak removing circuit tends to have a large circuit scale (area) and consume a large amount of electric power.

Usually, up converters (particularly, up converters using MOS transistors) suffer the problem of a local leak for outputting local signal components. With the UWB wireless communication apparatus, in particular, the amount of a local leak varies dependent on the frequency.

The local leak is represented by the sum of a local signal component output from an RF port of an up converter due to an offset voltage that is input to the baseband port of the up converter and a local signal component produced when a local signal leaks into the RF port of the up converter or a transmission power amplifier and is mixed with a transmission signal (local feedthrough phenomenon). Particularly, as the latter local signal component depends on the frequency, the local leak also varies in the hopping process.

Usually, in order to correct a local leak, there is employed an arrangement for applying a DC voltage to cancel the local leak to the baseband port of the up converter. With such an arrangement, however, each time a band is changed, a different DC voltage needs to be supplied fast and accurately to the baseband port of the up converter. Stated otherwise, it is difficult to realize a circuit for correcting a local leak, and even if such a circuit can be realized, it tends to have a large circuit scale (area) and consume a large amount of electric power. This problem is also caused because of fast hopping, and has not been experienced by the wireless communication apparatus according to the background art.

### SUMMARY

It is an exemplary object of the present invention to provide a wireless communication apparatus which is capable of alleviating the problem of an increased circuit area and increased power consumption, the problem of increased spurious emissions, and the problem of an offset and a local leak that are difficult to correct.

To achieve the above object, there is provided in accordance with the present invention a wireless communication apparatus for performing wireless communications while hopping, according to a predetermined sequence, between a plurality of bands each having a predetermined frequency range and making up a band group for wireless communications, comprising:

a local generator for generating a local signal having a frequency equal to the central frequency of the band group;

a first down converter for down-converting a wireless signal in each of the bands into an IF signal, using the local signal generated by the local generator;

a hopping complex filter for removing an image signal in the frequency range of a band to pass therethrough, among down-converted signals, the hopping complex filter having filter characteristics changeable depending on the hopping between the bands; and

a second down converter for converting an IF signal of a band which does not contain the central frequency, among signals having passed through the hopping complex filter, into a baseband signal in a predetermined frequency range about a DC level.

There is also provided a wireless communication apparatus for performing wireless communications while hopping, according to a predetermined sequence, between a plurality of bands each having a predetermined frequency range and making up a band group for wireless communications, comprising:

a local generator for generating a local signal having a frequency equal to the central frequency of the band group;

a first up converter for up-converting a baseband signal to be transmitted into an IF signal;

a hopping complex filter for removing an image signal in the frequency range of a band to pass therethrough, among up-converted signals, the hopping complex filter having filter characteristics changeable depending on the hopping between the bands; and

a second up converter for converting an IF signal of a band which does not contain the central frequency, among signals having passed through the hopping complex filter, into a signal having a wireless frequency of the band depending the hopping between the bands.

### BRIEF DESCRIPTION OF THE DRAWINGS

FIG. 1 is a diagram showing a hopping process of an UWB wireless communication apparatus according to the background art.

FIG. 2 is a block diagram showing the configuration of a UWB wireless communication apparatus according to a first exemplary embodiment of the present invention.

FIG. 3 is a diagram showing a hopping process of the UWB wireless communication apparatus shown in FIG. 2.

FIG. 4 is a diagram showing the manner in which symbols are extracted by the UWB wireless communication apparatus shown in FIG. 2.

FIG. 5 is a block diagram showing the configuration of a UWB wireless communication apparatus according to a second exemplary embodiment of the present invention.

FIG. 6 is a diagram showing the manner in which symbols are extracted by the UWB wireless communication apparatus shown in FIG. 5.

FIG. 7 is a block diagram showing the configuration of a UWB wireless communication apparatus according to a third exemplary embodiment of the present invention.

FIG. 8 is a circuit diagram showing a configurational example of a down converter with a block removing capability.

FIG. 9 is a block diagram showing the configuration of a UWB wireless communication apparatus according to a fourth exemplary embodiment of the present invention.

FIG. 10 is a diagram showing the manner in which symbols are extracted by the UWB wireless communication apparatus shown in FIG. 9.

FIG. 11 is a diagram showing configurational examples and characteristics of a hopping complex filter.

FIG. 12 is a block diagram showing the configuration of a UWB wireless communication apparatus according to a fifth exemplary embodiment of the present invention.

FIG. 13 is a diagram showing examples in which characteristics are changed by a filter shown in FIG. 12.

FIG. 14 is a diagram showing the manner in which symbols are extracted when an A/D converter shown in FIG. 5 is in an interleaving mode of operation.

FIG. 15 is a diagram showing the manner in which symbols are extracted when an A/D converter shown in FIG. 9 is in an interleaving mode of operation.

### EXEMPLARY EMBODIMENT

The present invention will be described below with reference to the drawings.

### 1st Exemplary Embodiment

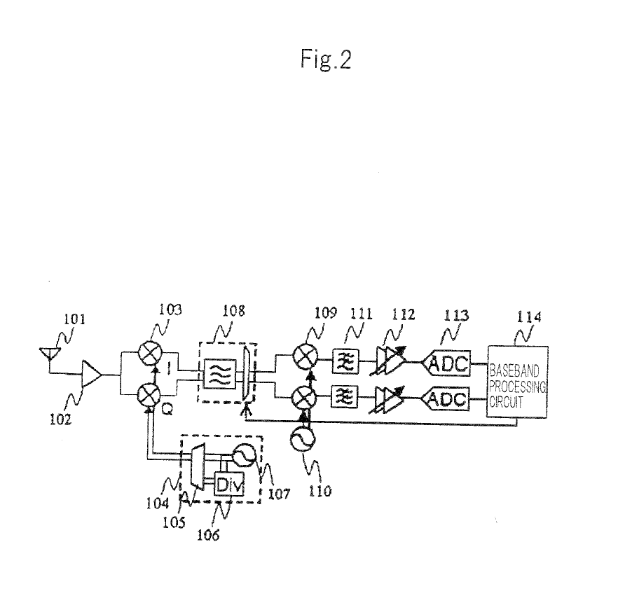

FIG. 2 is a block diagram showing the configuration of a UWB wireless communication apparatus according to a first exemplary embodiment of the present invention. In the first exemplary embodiment, a receiver provided in the wireless communication apparatus for receiving a UWB signal will be illustrated by way of example.

As shown in FIG. 2, the receiver according to the first exemplary embodiment includes reception antenna 101, low-noise amplifier (LNA) 102, first down converter 103, second local generator 104, hopping complex filter 108, second down converter 109, second local generator 110, low-pass filter (LPF) 111, variable-gain amplifier (VGA) 112, A/D converter 113, and baseband processing circuit 114. First local generator 10 comprises voltage-controlled oscillator (VCO) 107, frequency divider 106, and selector 105.

First local generator 104 shown in FIG. 2 will be described below.

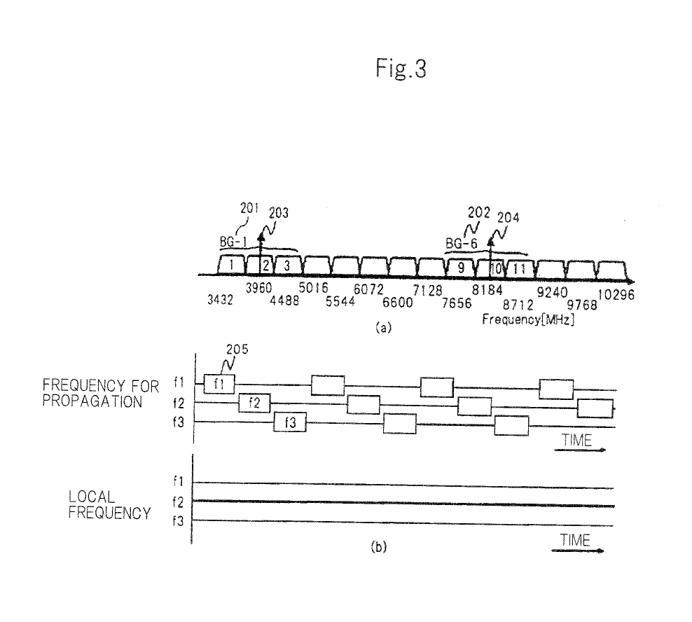

The UWB wireless communication apparatus sends and receives UWB signals in units of band groups each comprising three bands. Hopping is carried out between the three bands of the band groups, as shown in FIG. 3(b). In FIG. 3(b), hopping is carried out in the order of f1, f2, f3. The wireless communication apparatus has seven sequences of hopping, and can communicate with a plurality of UWB wireless communication apparatus that exist in the same communication area by selectively using different sequences (see, for example, High Rate Ultra Wideband PHY and MAC Standard, ECMA-368).

An example which uses first band group 201 shown in FIG. 3(a) will be described below.

First local generator 104 outputs a central frequency of 3960 MHz of the first band group. Since first band group 201 comprises a first band, a second band, and a third band, the frequency of 3960 MHz is also the central frequency of the second band.

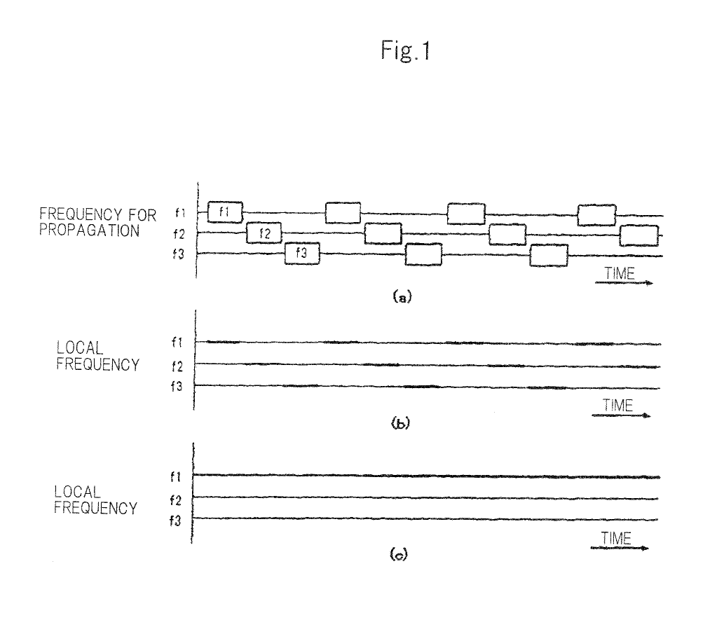

The UWB wireless communication apparatus according to the background art changes the frequency of a local signal in synchronism with the hopping process, as shown in FIG. 1(b). According to the present embodiment, the UWB wireless communication apparatus secures the frequency of a local signal to the central frequency of the band group, rather than changing the frequency of the local signal in synchronism with the hopping process, as shown in FIG. 3(b). If a different band group is used, then the UWB wireless communication apparatus secures the frequency of the local signal to the central frequency of the different band group. The UWB technology does not require that the switching between the band groups be performed fast. For example, if first band group 201 is to change to sixth band group 202, first local generator 104 changes from 3960 MHz which is the central frequency of the first band group, to 8184 MHz which is the central frequency of the sixth band group. The rate at which the frequencies change may be sufficiently lower than several μ seconds which are required to lock VCO 107 at the changed frequency.

The central frequency of 8184 MHz of the sixth band group is not an integral multiple of the central frequency of 3960 MHz of the first band group, but is about twice the latter central frequency. Therefore, if first local generator 104 has a divide-by-2 frequency divider, then it can generate local signals corresponding to the central frequencies of the first band group and the sixth band group simply by slightly changing the oscillation frequency of VCO 107. In this case, after the frequency-dividing ratio and the oscillation frequency are changed, VCO 107 may be locked to the changed frequency.

First local generator 104 shown in FIG. 2 is of a circuit configuration wherein VCO 107 generates a frequency in the vicinity of 8000 MHz and frequency divider 106 reduces the output frequency of VCO 107 to one half. If selector 105 receives the first band group, then it selects the output signal from frequency divider 106. If selector 105 receives the sixth band group, then it selects the output signal from VCO 107. At this time, VCO 107 may have a tuning range having a sufficient margin with respect to various variable factors including the process, the power supply voltage, the ambient temperature, etc. within a range from 7920 MHz which is twice the central frequency of the first band group to 8184 MHz which is the central frequency of the sixth band group.

In the above description, local signals for use in the first band group and the second band group are generated. First local generator 104 shown in FIG. 2 is also capable of generating local signals having frequencies for use in other band groups by changing the configurations of the oscillator and the frequency divider. Furthermore, first local generator 104 shown in FIG. 2 is also capable of generating local signals having frequencies for use not only two band groups, but also more band groups, by changing the configurations of the oscillator and the frequency divider.

Hopping complex filter 108 shown in FIG. 2 will be described below.

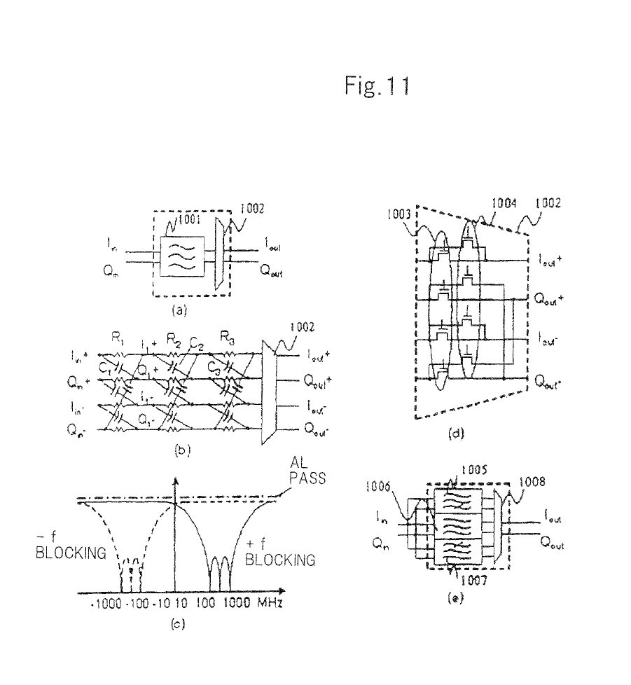

As shown in FIG. 11(a), hopping complex filter 108 comprises polyphase filter 1001 and selector 1002, and can switch fast between a plurality of filter characteristics according to a control signal output from baseband processing circuit 114, for example. Baseband processing circuit 114 may determine switching timing for the filter characteristics in synchronism established using the information stored in the preamble of a received UWB signal.

As shown in FIG. 11(b), polyphase filter 1001 comprises series-connected circuits in three stages each having four resistors and four capacitors, for example.

Though not shown in FIG. 11(a), polyphase filter 1001 is supplied with normal signals (Iᵢₙ+, Qᵢₙ+) of I and Q signals and inverted signals (I₁−, Qᵢₙ−) thereof. These signals have equal absolute values and are 90° out of phase successively in the order of Iᵢₙ+, Qᵢₙ+, Iᵢₙ−, Qᵢₙ−.

In polyphase filter 1001 shown in FIG. 11(b), the four resistors and the four capacitors in each of the stages have equal values. Specifically, resistors R₁ are disposed between Iᵢₙ+ and I₁+, between Qᵢₙ+ and Q₁+, between Iᵢₙ− and I₁−, and between Qᵢₙ− and Q₁−, and capacitors C₁ are disposed between Iᵢₙ+ and Q₁+, between Qᵢₙ+ and I₁−, between Iᵢₙ− and Q₁−, and between Qᵢₙ− and I₁+.

Similarly, resistors R₂ are disposed between I₁+ and I₂+, between Q₁+ and Q₂+, between I₁− and I₂−, and between Q₁− and Q₂−, and capacitors C₂ are disposed between I₁+ and Q₂+, between Q₁+ and I₂−, between I₁− and Q₂−, and between Q₁− and I₂+.

Furthermore, resistors R₃ are disposed between I₂+ and I₃+, between Q₂+ and Q₃+, between I₂− and I₃−, and between Q₂− and Q₃−, and capacitors C₃ are disposed between I₂+ and Q₃+, between Q₂+ and I₃−, between I₂− and Q₃−, and between Q₂− and I₃+.

With this arrangement, a signal input from Iᵢₙ+, for example, is output through resistor R₁ to I₁+, and a signal input from Qᵢₙ− which is −270° out of phase with Iᵢₙ+ is output through capacitor C₁ to I₁+. At this time, the signal input from Iᵢₙ+ and output to I₁+ has its phase remaining unchanged, and the signal input from Qᵢₙ− and output to I₁+ has its phase rotated by the impedance 1/jωCI of the capacitor C₁. Therefore, the signal having passed through resistor R₁ and the signal having passed through capacitor C₁ cancel out each other at I₁+.

The above process is also similarly performed on the signals input from Iᵢₙ+, Qᵢₙ+, Iᵢₙ−, Qᵢₙ−, and on the signals in the circuits at the respective stages. Therefore, polyphase filter 1001 shown in FIG. 11(b) is effective to block the passage of given frequency signals while keeping the I signals and the Q signals orthogonal to each other.

According to the present exemplary embodiment, the resistors and the capacitors in the stages of polyphase filter 1001 shown in FIG. 11(b) have different values R₁C₁, R₂C₂, R₃C₃. With these different values, the frequencies blocked by the stages of polyphase filter 1001 are of different values, thereby providing filter characteristics for preventing the passage of signals in a wide frequency range as shown in FIG. 11(c). The blocking capability of polyphase filter 1001 may be set to 40 dBc or higher depending on the orthogonality of the I signal and the Q signal.

Three downward peaks shown in FIG. 11(c) represent frequencies blocked by the respective stages of polyphase filter 1001 of the configuration shown in FIG. 11(b). Moreover, “−f BLOCKING” shown in FIG. 11(c) represents characteristics (hereinafter referred to as “−f blocking characteristics”) for blocking the passage of signals in a given negative frequency range (hereinafter referred to as “negative frequency”), “+f BLOCKING” represents characteristics (hereinafter referred to as “+f blocking characteristics”) for blocking the passage of signals in a given positive frequency range (hereinafter referred to as “positive frequency”), “ALL PASS” represents characteristics (hereinafter referred to as “all blocking characteristics”) for blocking the passage of all frequency signals without suppressing positive frequencies and negative frequencies.

If hopping complex filter 108 is set to the −f blocking characteristics, then it allows signals having positive frequencies to pass therethrough. If hopping complex filter 108 is set to the +f blocking characteristics, then it allows signals having negative frequencies to pass therethrough. If hopping complex filter 108 is set to the all blocking characteristics, then it allows signals having negative frequencies and positive frequencies to pass therethrough without blocking them.

For example, if C₁=C₂=C₃=1 pF, R₁=216Ω, R₂=320Ω, and R₃=567Ω, then hopping complex filter 108 provides blocking characteristics in a wide range from 264 to 792 MHz (or −264 to −792 MHz) required to remove image frequencies to be described later.

Hopping complex filter 108 is switched between the −f blocking characteristics and the +f blocking characteristics by selector 1002. As shown in FIG. 11(d), selector 1002 comprises first switch group 1003 and second switch group 1004.

When turned on, first switch group 1003 allows the I signals and the Q signals output from polyphase filter 1001 to pass therethrough. When turned on, second switch group 1004 allows the I signals output from polyphase filter 1001 to pass directly therethrough, and switch around and output the normal and inverted signals of the Q signals.

With such an arrangement, when the switches of first switch group 1003 are turned on and the switches of second switch group 1004 are turned off, hopping complex filter 108 is set to the −f blocking characteristics. When the switches of first switch group 1003 are turned off and the switches of second switch group 1004 are turned on, hopping complex filter 108 is set to the +f blocking characteristics.

As described above, since second switch group 1004 allows the I signals to pass directly therethrough, and switch around and output the normal and inverted signals of the Q signals, the parasitic capacitances of signal passages for the I signals and the Q signals or the charge injection and gate feed through of the switches may possibly be of different values, causing phase rotation tending to fail to keep the I signals and the Q signals orthogonal to each other. Accordingly, the switches of second switch group 1004 should preferably be arranged to have the above values equal to each other for keeping I signals and the Q signals orthogonal to each other.

Hopping complex filter 108 may be set to the all pass characteristics in any of the following ways:

For example, hopping complex filter 108 may include a third switch group (not shown) for interconnecting the input and output terminals thereof to provide passages for directly outputting the normal and inverted signals of the I signals and the Q signals input to hopping complex filter 108. Alternatively, capacitors C₁ through C₃ of polyphase filter 1001 shown in FIG. 11(b) may be disconnected by switches.

With the arrangement including the third switch group, when the −f blocking characteristics and the +f blocking characteristics are selected, signals are output through the resistors, and when the all pass characteristics are selected, signals are output through the switches. Therefore, the output signals are attenuated to different levels with the −f blocking characteristics, the +f blocking characteristics, and the all pass characteristics.

With the arrangement for disconnecting the capacitors of polyphase filter 1001 with the switches, since signals are output through the resistors also when the all pass characteristics are selected, the output signals are not attenuated to different levels with the −f blocking characteristics, the +f blocking characteristics, and the all pass characteristics. The arrangement including the third switch group can avoid the above problem if the input and output terminals of hopping complex filter 108 are interconnected by attenuators such as resistors or the like when the all pass characteristics are selected.

As shown in FIG. 11(e), hopping complex filter 108 may comprise first polyphase filter 1005 having only the −f blocking characteristics, second polyphase filter 1006 having the all pass characteristics, third polyphase filter 1007 having only the +f blocking characteristics, and selector 1008 for selecting output signals from those filters. Polyphase filter 1001 shown in FIG. 11(b) obtains the −f blocking characteristics and the +f blocking characteristics which are axisymmetric with respect to an axis representing a reference frequency (0 Hz) shown in FIG. 11(c). Hopping complex filter 108 shown in FIG. 11(e) is suitable for not making the −f blocking characteristics and the +f blocking characteristics axisymmetric.

The above configuration of hopping complex filter 108 serves to separate the received UWB signal into signals in three bands. However, the received UWB signal is not limited to being divided into signals in three bands, but may be divided into signals in any number of bands.

Operation of the receiver according to the first exemplary embodiment will be described

As described above, the UWB wireless communication apparatus hops fast between the bands shown in FIG. 3(b). The square marks in FIG. 3(b) represent OFDM symbols (hereinafter referred to as “unit symbols”) having a frequency range of about 500 MHz with an intersymbol interval of about 9.5 ns.

The frequency-hopped UWB signal is received by antenna 101 shown in FIG. 2, amplified by low-noise amplifier 102, and then input to the RF port of first down converter 103.

For example, if the first band group is received, then first down converter 103 is supplied with a local signal of 3960 MHz generated by first local generator 104. The UWB signal in the first through third bands that has been input to the RF port of first down converter 103 is down-converted into IF (Intermediate Frequency) signals in the frequency range from about −792 MHz to +792 MHz. First down converter 103 outputs I signals and Q signals as the IF signals which are 90° out of phase.

The I signals and the Q signals are produced when local signals are input to an I local port and a Q local port of first down converter 103. The I signals and the Q signals are differential signals and 90° out of phase successively in the order of I+, Q+, I−, Q−. These four IF signals are input to hopping complex filter 108.

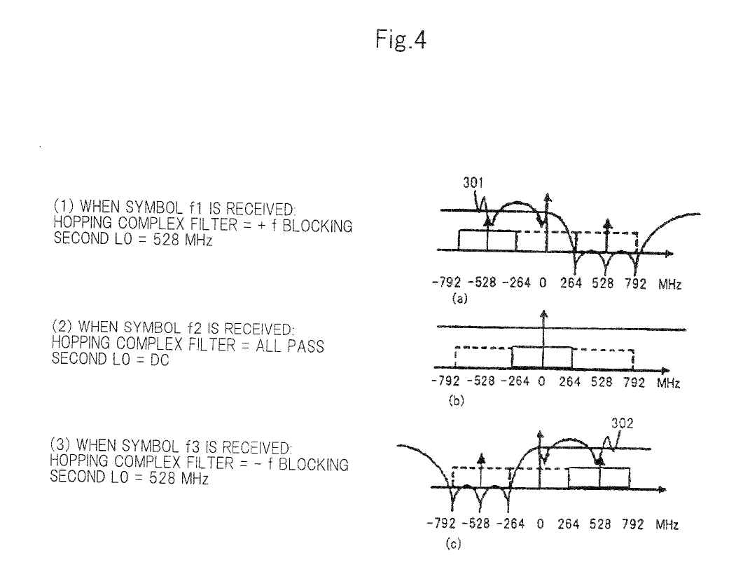

When symbol f1 shown in FIG. 3(b) is received, hopping complex filter 108 switches to the +f blocking characteristics shown in FIG. 11(c) under the control of baseband processing circuit 114. In this case, hopping complex filter 108 suppresses signal components at frequencies from +264 to +792 MHz of symbol f3 which are the image frequencies of symbol f1 (−792 to −264 MHz), as shown in FIG. 4(a). The IF signals that have passed through hopping complex filter 108 have a frequency range from −792 to +264 MHz, and include symbol f1 and symbol f2.

Second down converter 109 down-converts the IF signals in the frequency range from −792 to +264 MHz which are output from hopping complex filter 108, using local signal (second LO) 301 of 528 MHz generated by second local generator 110. At this time, symbol f1 at the frequencies from −792 to −264 MHz is converted into a baseband signal in the frequency range from −264 to +264 MHz which has a central frequency of 0 Hz (DC), shifting symbol f2 in the frequency range from −264 to +264 MHz out of the frequency range of the baseband signal.

The output signal from second down converter 109 is input to low-pass filter 111 which has a cut-off frequency of about 230 MHz. Low-pass filter 111 attenuates the power of symbol f2 and the power of other interferential waves, etc.

The output signal from low-pass filter 111 is amplified by variable-gain amplifier 112 to an amplitude matching the dynamic range of A/D converter 113. The output signal from variable-gain amplifier 112 is input to A/D converter 113.

A/D converter 113 converts the baseband signal (symbol f1) in the frequency range from −264 to +264 MHz into a digital signal at a conversion rate of 528 Msps, for example. Symbol f1 as converted into the digital signal is processed by baseband processing circuit 114 according to a known synchronism detecting process and an OFDM signal demodulating process.

When symbol f2 shown in FIG. 3(b) is received, hopping complex filter 108 switches to the all pass characteristics shown in FIG. 11(c) under the control of baseband processing circuit 114. In this case, hopping complex filter 108 allows signal components at frequencies from −264 to +264 MHz of symbol f2 which are output from first down converter 103, as shown in FIG. 4(b), to pass directly therethrough.

When symbol f2 is received, the LO port of second down converter 109 is supplied with a DC voltage (second LO) for correcting the offset of second down converter 109. Therefore, second down converter 109 outputs symbol f2 input from the RF port directly from the baseband port thereof. Alternatively, when symbol f2 is received, the output signal from hopping complex filter 108 may be supplied directly to low-pass filter 111, rather than passing through second down converter 109.

The output signal from second down converter 109 is input to low-pass filter 111 which has the cut-off frequency of about 230 MHz. Low-pass filter 111 attenuates the power of unwanted interferential waves, etc.

As with symbol f1, symbol f2 output from low-pass filter 111 is converted into a digital signal by A/D converter 113, and then processed by baseband processing circuit 114 according to the known synchronism detecting process and the OFDM signal demodulating process.

When symbol f3 shown in FIG. 3(b) is received, hopping complex filter 108 switches to the −f blocking characteristics shown in FIG. 11(c) under the control of baseband processing circuit 114. In this case, hopping complex filter 108 suppresses signal components at frequencies from −792+−264 MHz of symbol f1 which are the image frequencies of symbol f3 (+264 to +792 MHz), as shown in FIG. 4(c). The IF signals that have passed through hopping complex filter 108 have a frequency range from −264 to +792 MHz, and include symbol f2 and symbol f3.

Second down converter 109 down-converts the IF signals in the frequency range from −264 to +792 MHz which are output from hopping complex filter 108, using local signal 302 of 528 MHz generated by second local generator 110. At this time, symbol f3 at the frequencies from +264 to +792 MHz is converted into a baseband signal in the frequency range from −264 to +264 MHz which has a central frequency of 0 Hz (DC), shifting symbol f2 in the frequency range from −264 to +264 MHz out of the frequency range of the baseband signal.

The output signal from second down converter 109 is input to low-pass filter 111 which has the cut-off frequency of about 230 MHz. Low-pass filter 111 attenuates the power of symbol f2 and the power of other interferential waves, etc.

As with symbols f1, f2, symbol f2 output from low-pass filter 111 is converted into a digital signal by A/D converter 113, and then processed by baseband processing circuit 114 according to the known synchronism detecting process and the OFDM signal demodulating process.

With the wireless communication apparatus according to the first exemplary embodiment, the frequencies of the IF signals output from the first down converter can be made lower than with the arrangement for setting the frequencies of the local signals at the central frequencies of the bands as disclosed in Patent document 1, by setting the frequencies of the local signals at the central frequencies of the band groups. While the circuit in the stage subsequent to the first down converter is required to operate at 1320 MHz according to Patent document 2, the frequency at which the circuit operates may be 792 MHz which is about 1/1.7 of the above frequency according to the present exemplary embodiment. Furthermore, since one of the frequencies of the local signals is assigned to each band group, the local signals do not need to be generated using mixers and frequency dividers. Therefore, the circuit area and power consumption of local generator 104 are reduced, and the DC offset and the local leak are reduced.

Hopping complex filter 108 is capable of fast extracting the signal power at negative frequencies or positive frequencies by removing the image frequencies even if fast hopping takes place. Therefore, the operating frequency range of the circuit in the stage subsequent to the first down converter may be narrower than with the arrangement for setting the frequencies of the local signals in symbol f1 as disclosed in Patent document 2. Hopping complex filter 108 is also effective to reduce the effect of interferential waves, etc. that are present outside of the baseband frequency range. Furthermore, inasmuch as the second frequency of the second local signal may be of only 528 MHz, second down converter 109 can easily be constructed.

According to the present exemplary embodiment, furthermore, the conversion rate of the A/D converter is much lower than with the background art. According to the present exemplary embodiment, the positive frequency range and the negative frequency range of the IF signals are equal to each other because the frequencies of the local signals are set to the central frequencies of the band groups. Consequently, even if a single local signal is involved, the conversion rate required by the A/D converter may be held to a minimum. The circuit area and power consumption of A/D converter 113 are reduced.

Specifically, since only the symbol of one band having a frequency range of about 528 MHz (−264 to +264 MHz) may be subject to A/D conversion according to the present exemplary embodiment, the conversion rate of the A/D converter is about 528 MHz required to convert one symbol, and may be minimum.

According to Patent document 2, on the other hand, since the frequencies of the local signals are set to the frequency of symbol f1, the four symbols need to be converted altogether. Therefore, the conversion rate of the A/D converter is 2112 Msps. According to the present exemplary embodiment, the conversion rate of A/D converter 113 may be set to a value required to perform A/D conversion on two or more symbols.

The symbols used in the UWB wireless communication apparatus have a tone interval of 4.125 MHz, and the number of tones is 128. Therefore, the conversion rate required to perform A/D conversion on one symbol may be 528 Msps. However, if necessary, the conversion rate may he set to a non-integral multiple such as 1.1 times or 1.2 times. This is also applicable to D/A converters provided in a transmitter according to a fourth exemplary embodiment to be described later.

According to the present exemplary embodiment, as the image frequencies are suppressed by hopping complex filter 108, symbol f1 will not greatly be affected even when radio waves used in other wireless communication apparatus are mixed into the frequency range of symbol f3, for example. Furthermore, symbol f1 will not significantly be affected even if thermal noise, etc. is produced in the frequency range of symbol f3.

Inasmuch as hopping complex filter 108 according to the present exemplary embodiment is made up of capacitors, resistors, and switches only, it basically requires no steady current and has high linearity. It is of great significance for the UWB wireless communication apparatus, which includes many interferential sources such as wireless LANs and mobile phones, to have high linearity. It is also highly meritorious particularly for a receiver to have a configuration which is free of noise produced by active components. Active filters employing transconductance amplifiers, for example, are problematic in that they require high orders to obtain filter characteristics similar to those of hopping complex filter 108, have large steady currents, are difficult to achieve high linearity, and suffer large thermal noise and 1/f noise.

### 2nd Exemplary Embodiment

A second exemplary embodiment of the present invention will be described below with reference to the drawings.

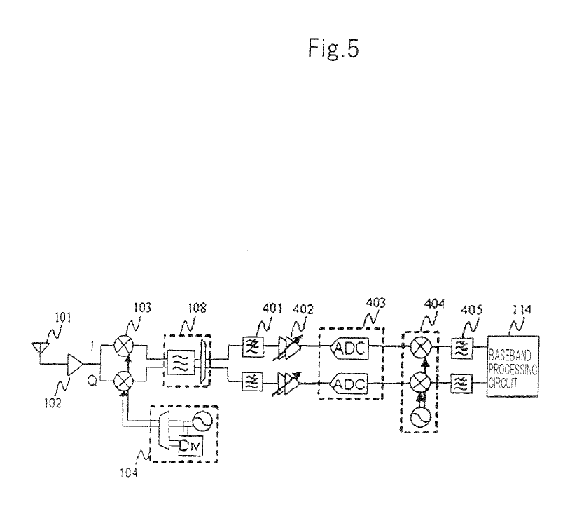

FIG. 5 is a block diagram showing the configuration of a UWB wireless communication apparatus according to the second exemplary embodiment of the present invention. In the second exemplary embodiment, a receiver for receiving a UWB signal will be illustrated by way of example, as with the first exemplary embodiment.

As shown in FIG. 5, the receiver according to the second exemplary embodiment includes reception antenna 101, low-noise amplifier (LNA) 102, first down converters 103, first local generator 104, hopping complex filter 108, and baseband processing circuit 114, which have been shown in the first exemplary embodiment, and additionally includes first low-pass filter 401, variable-gain amplifier 402, A/D converter 403, second down converter 404, and second low-pass filter 405.

In the receiver according to the second exemplary embodiment, second down-converter 404 is implemented by digital signal processing. Reception antenna 101, low-noise amplifier (LNA) 102, first down converter 103, first local generator 104, hopping complex filter 108, and baseband processing circuit 114 have the same configuration as those of the receiver according to the first exemplary embodiment, and will not be described below.

Low-pass filter 401, which has a cut-off frequency of about 792 MHz, allows frequency components from symbol f1 to symbol f3 output from hopping complex filter 108 to pass therethrough, and attenuates higher frequency components. Low-pass filter 401 is provided for attenuating unwanted radio waves (so-called blockers) and noise, etc. which are present outside of the frequency range used by the UWB wireless communication apparatus.

Variable-gain amplifier 402 amplifies the output signal from low-pass filter 401 to an amplitude matching the dynamic range of A/D converter 403, as with the first exemplary embodiment. Variable-gain amplifier 402 according to the present exemplary embodiment is required to amplify signals having frequencies up to about 792 MHz.

A/D converter 403 according to the present exemplary embodiment has a conversion rate for converting IF signals in a frequency range from −528 to +528 MHz. When A/D conversion is performed on the IF signals at such a conversion rate, signal components at frequencies from −792 to −528 MHz of symbol f1, for example, outside of the Nyquist frequency appear in the frequency range from +264 to +528 MHz of symbol f3. This is caused by an alias produced about the Nyquist frequency of 528 MHz by the A/D conversion.

When symbol f1, for example, is received, signal components at the frequencies of symbol f3 have already been removed from the IF signals input to A/D converter 403 by hopping complex filter 809. Therefore, no problem arises even if signal components of symbol f1 appear in the frequency range of symbol f3 by the A/D conversion.

Second down converter 404 according to the present exemplary embodiment has the same functions as second down converter 109 according to the first exemplary embodiment, and is implemented by the digital signal processing described above. The functions of second down converter 404 can be achieved by a reconfigurable device whose internal circuit can be changed by a program, a CPU for performing processing operation according to a program, or a DSP for performing arithmetic operation.

Operation of the receiver according to the second exemplary embodiment shown in FIG. 5 will be described below with reference to the drawings.

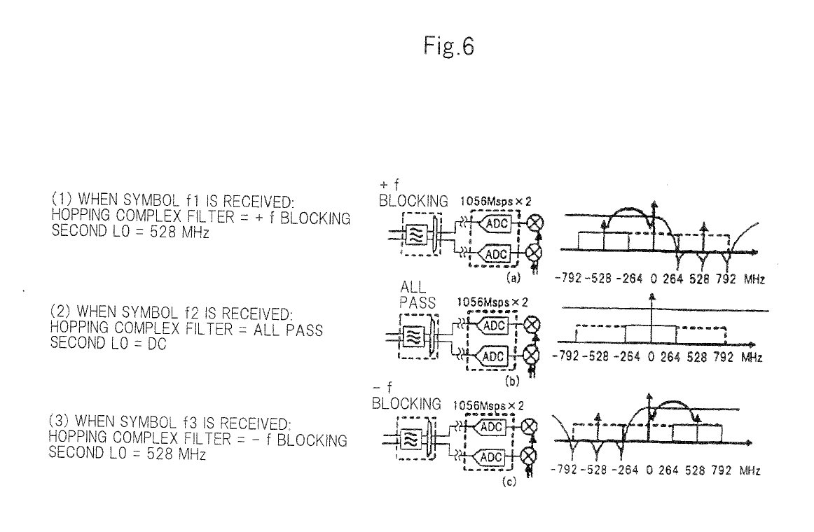

When symbol f1 is received (FIG. 6(a)), hopping complex filter 108 switches to the +f blocking characteristics shown in FIG. 11(c) under the control of baseband processing circuit 114 as with the first exemplary embodiment. In this case, hopping complex filter 108 suppresses signal components at frequencies from +264 to +792 MHz of symbol f3 which are the image frequencies of symbol f1 (−792 to −264 MHz). The IF signals that have passed through hopping complex filter 108 have a frequency range from −792 to +264 MHz, and include symbol f1 and symbol f2.

The IF signals that have passed through hopping complex filter 108 are input to first low-pass filter 401. First low-pass filter 401 allows signal components of symbol f1 and symbol f2 to pass therethrough and suppresses unwanted radio waves and noise outside of the cut-off frequency thereof.

The IF signals that have passed through first low-pass filter 401 are amplified by second variable-gain amplifier 402, and input to A/D converter 403.

A/D converter 403 converts symbol f1 included in the IF signals into a digital signal including signal components at frequencies from −528 to −264 MHz and from +264 to +528 MHz, and converts symbol f2 into a digital signal including signal components at frequencies from −264 to +264 MHz, using a local signal (second LO) of 528 MHz. The IF signals as converted into the digital signals by A/D converter 403 are input to second down converter 404.

Second down converter 404 down-converts the IF signals as converted into the digital signals, as with second down converter 109 according to the first exemplary embodiment. At this time, symbol f1 made up of signal components at the frequencies from −528 to −264 MHz and from +264 to +528 MHz is converted into a baseband signal in the frequency range from −264 to +264 MHz which has a central frequency of 0 Hz (DC), shifting symbol f2 in the frequency range from −264 to +264 MHz out of the frequency range of the baseband signal.

The output signal from second down converter 404 is input to second low-pass filter 405 which has a cut-off frequency of about 230 MHz, Second low-pass filter 405 attenuates the power of symbol f2 and the power of other interferential waves, etc.

Symbol f1 which has passed through second low-pass filter 405 is input to and processed by baseband processing circuit 114 according to the known synchronism detecting process and the OFDM signal demodulating process.

When symbol f2 is received (FIG. 6(b)), hopping complex filter 108 switches to the all pass characteristics shown in FIG. 11(c) under the control of baseband processing circuit 114. In this case, hopping complex filter 108 allows signal components at frequencies from −264 to +264 MHz of symbol f2 output from first down converter 103 to pass directly therethrough.

The IF signals that have passed through first low-pass filter 401 amplified by second variable-gain amplifier 402, and input to A/D converter 403.

A/D converter 403 converts symbol f2 at the frequencies from −264 to +264 MHz included in the IF signals into a digital signal. The IF signals as converted into the digital signals by A/D converter 403 are input to second down converter 404.

Second down converter 404 directly outputs symbol f2 as converted into the digital signal, without down-converting same using a DC voltage as a local signal (second LO), as with second down converter 109 according to the first exemplary embodiment.

The output signal from second down converter 404 is input to second low-pass filter 405 which has the cut-off frequency of about 230 MHz. Second low-pass filter 405 attenuates the power of unwanted interferential waves, etc.

Symbol f2 which has passed through second low-pass filter 405 is input to and processed by baseband processing circuit 114 according to the known synchronism detecting process and the OFDM signal demodulating process.

When symbol f3 is received (FIG. 6(c)), hopping complex filter 108 switches to the −f blocking characteristics shown in FIG. 11(c) under the control of baseband processing circuit 114 as with the first exemplary embodiment. In this case, hopping complex filter 108 suppresses signal components at frequencies from −792 to −264 MHz of symbol f1 which are the image frequencies of symbol f3 (+264 to +792 MHz). The IF signals that have passed through hopping complex filter 108 have a frequency range from +264 to +792 MHz, and include symbol f2 and symbol f3.

The IF signals that have passed through hopping complex filter 108 are input to first low-pass filter 401. First low-pass filter 401 allows signal components of symbol f2 and symbol f3 to pass therethrough and suppresses unwanted radio waves and noise outside of the cut-off frequency thereof.

The IF signals that have passed through first low-pass filter 401 are amplified by second variable-gain amplifier 402, and input to A/D converter 403.

A/D converter 403 converts symbol f3 included in the IF signals into a digital signal including signal components at frequencies from −528 to −264 MHz and from +264 to +528 MHz, and converts symbol f2 into a digital signal including signal components at frequencies from −264 to +264 MHz. The IF signals as converted into the digital signals by A/D converter 403 are input to second down converter 404.

Second down converter 404 down-converts the IF signals as converted into the digital signals, using a local signal (second LO) of 528 MHz, as with second down converter 109 according to the first exemplary embodiment. At this time, symbol f3 made up of signal components at the frequencies from −528 to −264 MHz and from +264 to +528 MHz is converted into a baseband signal in the frequency range from −264 to +264 MHz which has a central frequency of 0 Hz (DC), shifting symbol f2 in the frequency range from −264 to +264 MHz out of the frequency range of the baseband signal.

The output signal from second down converter 404 is input to second low-pass filter 405 which has the cut-off frequency of about 230 MHz. Second low-pass filter 405 attenuates the power of symbol f2 and the power of other interferential waves, etc.

Symbol f3 which has passed through second low-pass filter 405 is input to and processed by baseband processing circuit 114 according to the known synchronism detecting process and the OFDM signal demodulating process.

The receiver according to the second exemplary embodiment offers advantages, in addition to the advantages obtained by securing the local frequencies for the respective band groups and the advantages obtained by using the hopping complex filter, as indicated by the first exemplary embodiment, in that only one event of down conversion takes place using an analog circuit, and mixers and local generators required for a second event of down conversion are not required. Therefore, circuit areas and power consumption required by those mixers and local generators are reduced.

Furthermore, since A/D converter 403 has a conversion rate of about 1 Gsps, its power consumption can be reduced to about one-half of the power consumption of the arrangement which requires a conversion rate of about 2 Gsps according to Patent document 2.

Moreover, the frequency of the signal that passes through variable-gain amplifier 402 may be of about 792 MHz, which is lower than 1.3 GHz according to the background art. The reduction in the operating frequency of variable-gain amplifier 402 makes it possible to increase the gain per amplifier stage based on the principle that the known gain-bandwidth product is constant. Therefore, the number of amplifier stages can be reduced to reduce the circuit area and power consumption of variable-gain amplifier 402.

The receiver according to the present exemplary embodiment can employ a configuration for interleaving in A/D converter 403. Specifically, A/D converter 403 has two A/D converters for an I signal and a Q signal, and performs an interleaving mode for performing A/D conversion directly on the I signal and the Q signal and performing A/D conversion on either one of the I signal and the Q signal, for thereby obtaining a conversion rate which is twice the conversion time of one A/D converter.

For example, if the A/D converter has a conversion rate of 1056 Msps, then usually it converts the I signal and the Q signal at 1056 Msps, and, in the interleaving mode it converts either one of the I signal and the Q signal at 2112 Msps which is a rate that is twice 1056 Msps.

Such a configuration may include a selector placed immediately before the A/D converters for allowing the I signal and the Q signal to pass directly therethrough and inputting only the I signal or the Q signal to the two A/D converters.

Alternatively, a selector may be placed on the output side of the A/D converters for allowing the I signal and the Q signal which have been converted to pass directly therethrough and rearranging signals that are alternately output from the A/D converters in an appropriate sequence in the interleaving mode.

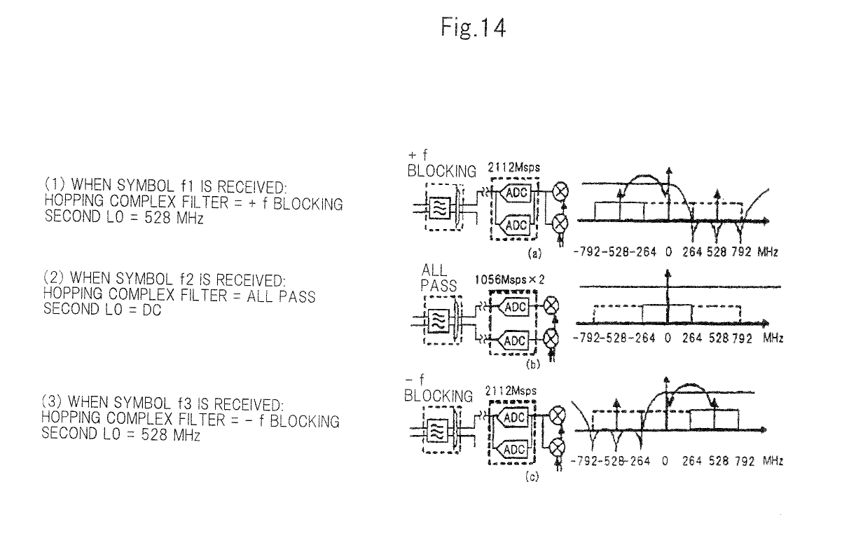

Operation of the A/D converters in the interleaving mode is shown in FIG. 14.

In the present exemplary embodiment, when symbols f1, f3 are received, A/D converter 403 operates in the interleaving mode, and when symbol f2 is received, A/D converter 403 does not operate in the interleaving mode.

When symbol f1 is received, A/D converter 403 outputs either one of the I signal and the Q signal of symbol f1, which is input to second down converter 404.

As with the second down converter according to the first exemplary embodiment, second down converter 404 down converts input symbol f1 in the frequency range from −792 to −264 MHz into a baseband signal in the frequency range from −264 to +264 MHz (FIG. 14(a)). At this time, symbol f2 in the frequency range from −264 to +264 MHz is shifted out of the frequency band of the baseband signal.

When symbol f2 is received, symbol f2 passes directly through hopping complex filter 103, and is input to second A/D converter 403 (FIG. 14(b)).

A/D converter 403 does not operate in the interleaving mode, but causes the A/D converters thereof to perform A/D conversion on the I signal and the Q signal. Since no interleaving mode takes place, the I signal and the Q signal are converted at a conversion rate of 1056 Msps. The signal of symbol f2 is present in the frequency range from −264 to 264 MHz, and the Nyquist frequency of the ND conversion is of 528 MHz which is ½ of 1056 MHz, so that the A/D conversion can be performed with a sufficient margin.

According to the present exemplary embodiment, as described above, the frequency components from −528 to −792 MHz of symbol f1 are folded back into −264 to −528 MHz, but cause no problem because they do not overlap the frequencies of symbol f2. Similarly, the frequency components from 528 to 792 MHz cause no problem.

When symbol f3 is received, hopping complex filter 108 switches to the −f blocking characteristics, and allows symbol f3 to pass therethrough while suppressing the frequencies of symbol f1, as with the first exemplary embodiment (FIG. 14(c)).

A/C converter 403 operates in the interleaving mode as with symbol f1, and performs A/D conversion on only one of the I signal and the Q signal. The A/D-converted signal is input to down converter 404 and converted thereby into a baseband signal, which is output.

Even when A/D converter 403 operates in the interleaving mode, it has a conversion rate of about 1 Gsps, which is effective to reduce the power consumption to about one-half of the power consumption of the arrangement which uses a conversion rate of about 2 Gsps according to the background art.

According to the present exemplary embodiment, since the conversion rate of about 1 Gsps is sufficient for converting two symbols in the frequency range of about 528 MHz, the conversion rate required to convert four symbols as disclosed in Patent document 2 is not necessary.

### 3rd Exemplary Embodiment

A third exemplary embodiment of the present invention will be described below with reference to the drawings.

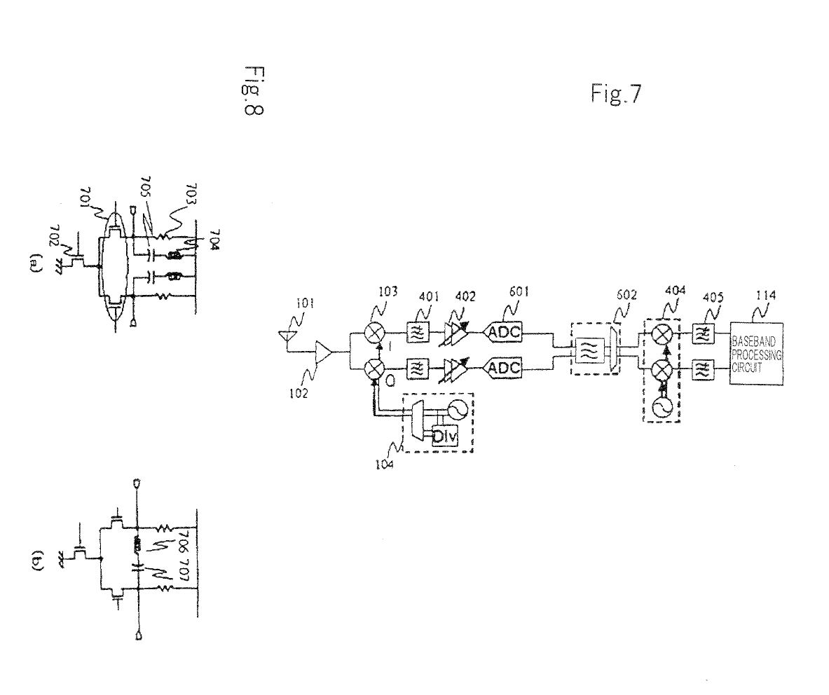

FIG. 7 is a block diagram showing the configuration of a UWB wireless communication apparatus according to the third exemplary embodiment of the present invention. In the third exemplary embodiment, a receiver for receiving a UWB signal will be illustrated by way of example, as with the first and second exemplary embodiments.

As shown in FIG. 7, the receiver according to the third exemplary embodiment includes reception antenna 101, low-noise amplifier (LNA) 102, first down converter 103, first local generator 104, first low-pass filter 401, variable-gain amplifier 402, second down converters 404, second low-pass filter 405, and baseband processing circuit 114, which have been shown in the second exemplary embodiment, and additionally includes A/D converters 601 and hopping complex filter 602.

The receiver according to the third exemplary embodiment is different from the receiver according to the second exemplary embodiment in that hopping complex filter 602 is implemented by digital signal processing. The functions of hopping complex filter 602 can be achieved by a reconfigurable device whose internal circuit can be changed by a program, a CPU for performing processing operation according to a program, or a DSP for performing arithmetic operation. The configuration and operation of reception antenna 101, low-noise amplifier (LNA) 102, first down converters 103, first local generator 104, and baseband processing circuit 114 are identical to those of the receiver according to the first exemplary embodiment, and the configuration and operation of first low-pass filter 401, variable-gain amplifier 402, second down converter 404, and second low-pass filter 405 are identical to those of the receiver according to the second exemplary embodiment, so that they will not be described below.

As shown in FIG. 7, the receiver according to the present exemplary embodiment has no hopping complex filter in a state subsequent to first down converters 103. First low-pass filters 401 and variable-gain amplifiers 402 operate in the same manner as those according to the second exemplary embodiment. The output signals from first low-pass filters 401 are converted into digital signals by A/D converters 601.

A/D converter 601 according to the present exemplary embodiment has a conversion rate of 1584 Msps and converts symbol F1 through symbol F3 altogether into a digital signal. The output signal from A/D converter 601 is input to second down converter 404. Subsequent operation of second down converter 404 is the same as with the second exemplary embodiment.

According to the present exemplary embodiment, hopping complex filter 602 is implemented by digital signal processing. Therefore, the present exemplary embodiment offers advantages, in addition to the advantages according to the first and second exemplary embodiments, in that the number of analog circuits can be smaller than with the second exemplary embodiment. The arrangement will be capable of making the circuit area smaller than with the second exemplary embodiment in the future, and can reduce the problem of crosstalk, etc. which occurs when the receiver is made up of analog circuits.

As described above, A/D converter 601 according to the present exemplary embodiment has the conversion rate of 1584 Msps. Since it performs A/D conversion on three symbols in the frequency range of about 528 Msps altogether, the conversion rate of A/D converter 601 may be of about 1584 Msps. Although the conversion rate of A/D converter 601 according to the present exemplary embodiment is higher than with the second exemplary embodiment, it may be about ¾ of the conversion rate according to the background art, and hence the power consumption may also be ¾ of the power consumption according to the background art. First down converter 103 according to the present exemplary embodiment should preferably have a blocker removing capability.

Configurational examples of a down converter with a blocker removing capability which is suitable for use as first down converter 103 are shown in FIG. 8.

First down converter 103 shown in FIG. 8(a) comprises differential transistor pair 701 and tail transistor 702.

Differential transistor pair 701 and tail transistor 702 make up a single balanced mixer. Inductors 704 and capacitors 705 which are connected in series with each other are connected parallel to load resistors 703.

With the arrangement shown in FIG. 8(a), inductors 704 and capacitors 705 are low in resistance in the vicinity of the resonant frequency, lowering the load impedance to lower the conversion gain of the mixer. Therefore, by selecting the resonant frequency as the blocker frequency, the mixer can have a blocker removing capability.

For receiving the first band group described above, for example, the frequency of local signals input to first down converter 103 is set to a central frequency of 3960 MHz. In this case, a radio wave of 5.2 GHz for use in the wireless LAN in accordance with 802.11a is present as a blocker. The frequency is about 1.2 GHz spaced from 3960 MHz.

First down converter 103 operates in an IF frequency range from about −0.8 to 0.8 GHz. It is preferable that the IF output of the first down converter be allowed to pass up to 0.8 GHz and the blocker in the vicinity of 1.2 GHz be attenuated. Therefore, the blocker can greatly be attenuated by setting the resonant frequency provided by inductors 704 and capacitors 705 shown in FIG. 8(a) to 1.2 GHz.

First down converter 103 shown in FIG. 8(b) comprises inductor 706 and capacitor 707 which are connected in series to each other between differential outputs. This arrangement can provide the same advantages as those of first down converter 103 shown in FIG. 8(a). Although the arrangement shown in FIG. 8(b) is unable to remove a common mode signal, its circuit area can be reduced because the number of components used is reduced.

Usually, since the wireless LAN has a large transmission power, the attenuation level for the blocker in the vicinity of 1.2 GHz should preferably be of 40 dB or higher. However, as the frequency difference between 0.8 GHz and 1.2 GHz is small, it is necessary to increase the order of the low-pass filter for removing the blocker in the wireless LAN while allowing signals in the frequency range used by the WEB wireless communication apparatus to pass therethrough. Accordingly, the circuit area and power consumption of the low-pass filter are increased. The circuit arrangements shown in FIGS. 8(a) and 8(b) for use as first down converter 103 are effective to reduce the circuit area and power consumption of the low-pass filter.

### 4th Exemplary Embodiment

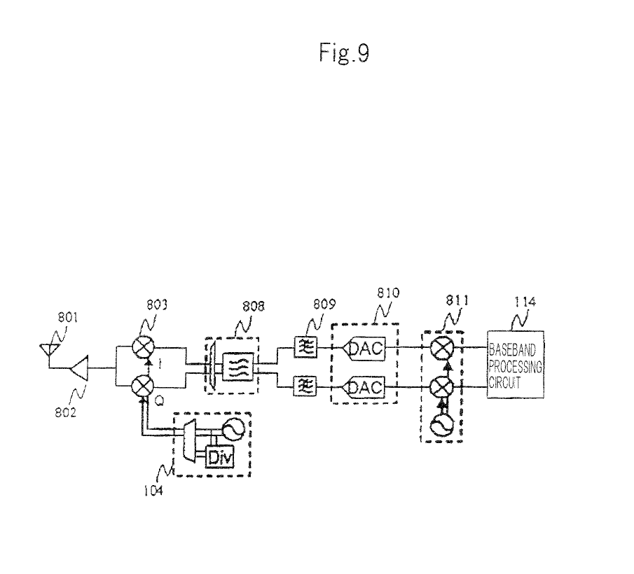

FIG. 9 is a block diagram showing the configuration of a UWB wireless communication apparatus according to a fourth exemplary embodiment of the present invention. In the fourth exemplary embodiment, a transmitter for transmitting a UWB signal will be illustrated by way of example.

As shown in FIG. 9, the transmitter according to the present exemplary embodiment comprises baseband processing circuit 114, first up converter 811, D/A converter 810, low-pass filter 809, hopping complex filter 808, first local generator 104, second up-converter 803, power amplifier 802, and transmission antenna 801.

First up converter 811 is implemented by digital signal processing, and converts a baseband signal in a frequency range from −264 to +264 MHz into an IF signal in a frequency range from 264 to 792 MHz having a central frequency of 528 MHz, using a local signal of 528 MHz, for example. Since first up converter 811 is not required to convert frequencies when transmitting symbol f2, as with the receiver, first up converter 811 may allow the input signal from baseband processing circuit 144 to pass directly therethrough.

D/A converter 810 according to the present exemplary embodiment may perform D/A conversion on frequencies from the central frequency of symbol f1 to the central frequency of symbol f3. Specifically, D/A converter 810 has a conversion rate for performing D/A conversion on an IF signal in a frequency range from −528 to +528 MHz.

When D/A conversion is performed at such a conversion rate, then signal components in the frequency range from −792 to −528 MHz of symbol f1 appear in the frequency range from +264 to +528 MHz of symbol f3. This is because an alias is produced about the Nyquist frequency of 528 MHz by the D/A conversion.

With the transmitter according to the present exemplary embodiment, when symbol f1, for example, is transmitted, signal components at the frequencies of symbol f3 are removed by hopping complex filter 808. Therefore, no problem arises even if signal components of symbol f1 appear in the frequency range of symbol f3 by the D/A conversion.

Low-pass filter 809 allows signals to pass through the IF frequency range from −792 to +792 MHz and attenuates signals outside of the IF frequency range. When symbol f1 or symbol f3 is transmitted, the frequencies of symbol f2 represent no signal (null), and hence an alias produced at the frequencies below those of symbol f1 and above those of symbol f3 also becomes null.

Since the frequency range of symbol f2 is of about 528 MHz, the null of the alias has a bandwidth of about 528 MHz. Specifically, when symbol f1 and symbol f2 are transmitted, signals are present in a frequency range up to an absolute value of about 792 MHz, and the null has an interval from 792 to 1320 MHz, so that the low-pass filter is not required to have sharp attenuation characteristics. Therefore, the order of the low-pass filter can be lowered.

When symbol f2 is transmitted, an alias is produced at frequencies higher than 792 MHz, and signals in a frequency range from 264 to 792 MHz become null. Therefore, when symbol f2 is selected, the cut-off frequency of low-pass filter 809 should preferably be set to a value lower than when symbol f1 and symbol f3 are transmitted, permitting a low-pass filter of relatively low order to be used when symbol f2 is transmitted. However, if the power consumption and circuit area of the overall transmitter are not affected by the use of a high-order filter, then a low-pass filter with its cut-off frequency being secured to 792 MHz may be used.

Hopping complex filter 809 has the same function as hopping complex filter 108 used in the receiver. However, the hopping complex filters in the receiver and the transmitter may have different filter characteristics if necessary.

Operation of the transmitter according to the fourth exemplary embodiment will be described below.

Baseband processing circuit 114 shown in FIG. 9 outputs an OFDM baseband signal for transmission which is input to first up converter 811.

When symbol f1 is transmitted, first up converter 811 converts the baseband signal which is about a DC level into an IF signal which is about 528 MHz, for example. The IF signal output from first up converter 811 is input to D/A converter 810.

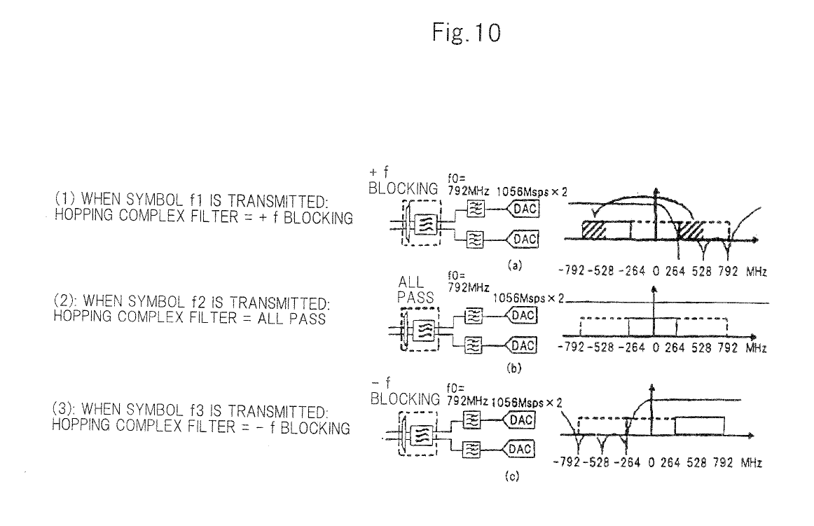

As described above, since D/A converter 810 according to the present exemplary embodiment has a sampling frequency and a conversion rate of 1056 MHz and a Nyquist frequency of 528 MHz, signals in a frequency range from +264 to +528 MHz appear as an alias in the frequency range from −792 to −528 MHz of symbol f1, as shown in shaded area of FIG. 10(a).

Low-pass filter 809 removes unwanted signals with a cut-off frequency of 792 MHz or higher. The unwanted signals include the unwanted alias of 1320 MHz or higher referred to above. The output signal from low-pass filter 809 is input to hopping complex filter 808.

When symbol f1 is transmitted, hopping complex filter 808 switches to the +f blocking characteristics for suppressing the frequency components of symbol f3 and allowing symbol f1 to pass therethrough. The output signal from hopping complex filter 808 is input to the IF port of second up converter 803.

Second up converter 803 converts the IF signal into an RF signal, using a local signal generated by first local generator 104. The output signal from second up converter 803 is input to power amplifier 802, which amplifies the signal to a predetermined transmission level. The amplified signal is then radiated into space via transmission antenna 801.

When symbol f2 is transmitted, first up converter 811 directly outputs symbol f2 without up-converting same. The up-conversion process of first up converter 811 may be stopped by a process wherein a DC signal is input as a local signal to first up converter 811 or a process wherein a switch or the like is used to provide a path for bypassing first up converter 811.

Symbol f2 that has passed through first up converter 811 is converted by D/A converter 810 into an analog signal, from which an unwanted alias is removed by low-pass filter 809.

Since symbol f1 and symbol f3 have no signal at this time, as shown in FIG. 10(b), it is possible to provide a transition range in this area, as described above, and the low-pass filter may be of a relatively low order. Preferably, when symbol f2 is selected, low-pass filter 809 is switched to a lower cut-off frequency than when symbol f1 and symbol f3 are transmitted. Hopping complex filter 808 switches to the all pass characteristics, and allows symbol f2 to pass therethrough.

When symbol f3 is transmitted, hopping complex filter 808 switches to the −f blocking characteristics for suppressing the frequency components of symbol f1 and allowing symbol f3 to pass therethrough (see FIG. 10(c)).

The frequency of a local signal generated by first local generator 104 is the central frequency of each band group as with the receivers according to the first through third exemplary embodiments, and is a frequency secured to each band group even when frequency hopping is performed. In other words, the frequency of the local signal is only one for each band group.

Therefore, the transmitter according to the present exemplary embodiment is capable of making less intensive the problem of a local leak caused by variations of the components that make up second up converter 803. For example, if there are three local frequencies, then it is necessary to correct a local leak for each of the three frequencies. Therefore, the scale of a correcting circuit such as D/A converter used for correction is large. For fast frequency hopping, furthermore, it is necessary to perform fast switching on the D/A converter used for correction, resulting in an increase in the power consumption.

With the transmitter according to the present exemplary embodiment, as a local leak to be corrected is of one frequency only, it is not necessary to change the corrective variable depending on the hopping. Therefore, the circuit scale and power consumption for correction can greatly be reduced. According to the present exemplary embodiment, furthermore, since D/A conversion is performed on two symbols having a frequency range of about 528 MHz, the conversion rate of the D/A converter may be of about 1 Gsps.

With the transmitter according to the present exemplary embodiment, the positive frequency range and the negative frequency range of the IF signal are equal to each other because the frequencies of the local signal generated by the local generator are set to the central frequencies of the band groups. Consequently, even if a single local signal is involved, the conversion rate required by the D/A converter may be held to a minimum. Furthermore, since the frequency the local signal is assigned to each band group, the local signal does not need to be generated using mixers and frequency dividers.

The hopping complex filter which is capable of switching between the filter characteristics makes it possible to remove an image signal which changes upon hopping between the bands, for thereby extracting a signal of a desired band. Accordingly, a large-scale circuit and a fast operating circuit do not need to be used for the local generator, the D/A converter, etc. Therefore, the circuit area and power consumption of the local generator, the D/A converter, etc. can be reduced, and a local leak and a spurious which are produced by fast hopping can also be reduced.

The transmitter according to the present exemplary embodiment can employ a configuration for interleaving in D/A converter 810.

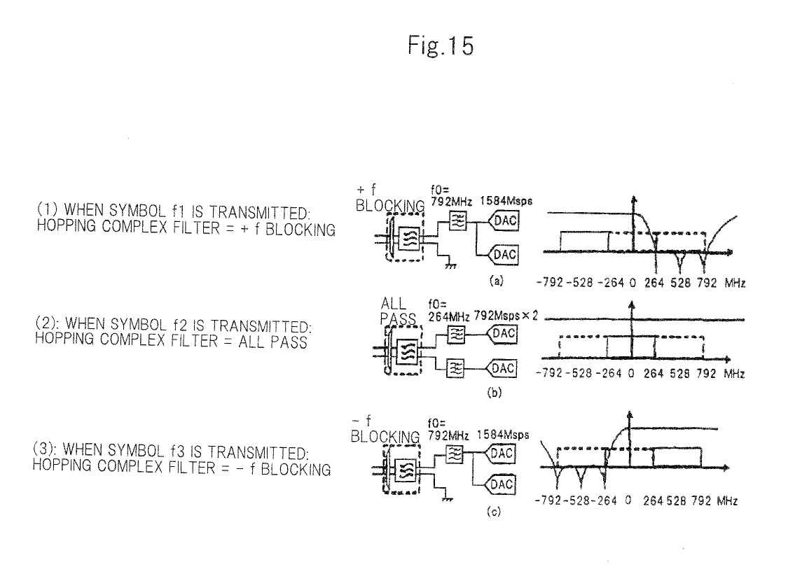

FIG. 15 shows a configurational example for switching on and off an interleaving mode of operation with two D/A converters.

The D/A converters shown in FIG. 15 may have a conversion rate which is about one-half or more of the conversion rate required to perform D/A conversion on symbol f1 through symbol f3. Specifically, since symbol f1 through symbol f3 have frequencies ranging generally from −792 to +792 MHz, the conversion rate usually needs to be of 1584 Msps for covering the above range. According to the present exemplary embodiment, however, the conversion rate may be of about 792 MHz or higher.

This is because hopping complex filter 808 with the +f blocking characteristics or the −f blocking characteristics removes an unwanted frequency range. For example, when symbol f1 is transmitted, D/A converter 810 operates in the interleaving mode. In this case, two D/A converters with the conversion rate of 792 Msps operate in the interleaving mode to permit D/A converter 810 to have a twofold conversion rate of 1584 Msps. Thus, D/A conversion is performed on either one of the I signal and the Q signal, e.g., only the I signal. An image signal produced when D/A conversion is performed on only one signal (symbol f3 if symbol f1 is transmitted) is removed by hopping complex filter 808. In other words, hopping complex filter 808 is effective to extract only symbol f1.

When symbol f2 is transmitted, D/A converter 810 does not operate in the interleaving mode, but the two D/A converters perform D/A conversion on the I signal and the Q signal, respectively. At this time, the conversion rate is of 792 Msps, and the Nyquist frequency is of 396 MHz which is one-half of the conversion rate. As symbol f2 is present in a frequency range up to an absolute value of 264 MHz, it can be converted into an analog signal with a sufficient margin.

When symbol f3 is transmitted, D/A converter 810 operates in the interleaving mode, as when symbol f1 is transmitted. At this time, hopping complex filter 808 switches to the −f blocking characteristics for blocking the frequency components of symbol f1 and allowing symbol f3 to pass therethrough.

Since D/A converter 810 operates in the interleaving mode and hopping complex filter 808 is provided, the conversion rate of D/A converter 810 can be lowered, thereby reducing the power consumption and circuit area of D/A converter 810.

### 5th Exemplary Embodiment

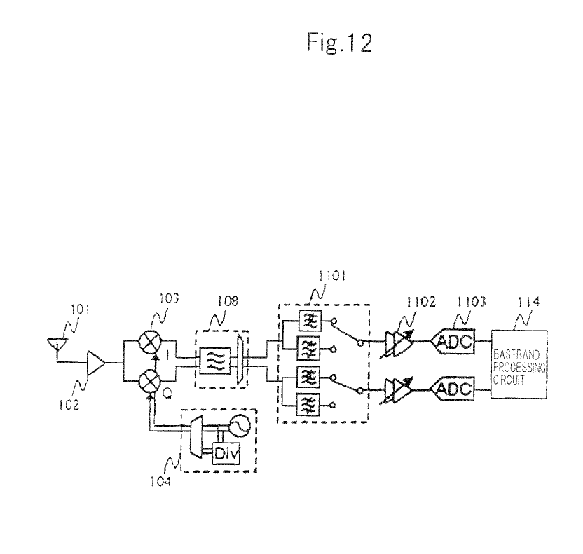

FIG. 12 is a block diagram showing the configuration of a UWB wireless communication apparatus according to a fifth exemplary embodiment of the present invention. In the fifth exemplary embodiment, a receiver for receiving a UWB signal will be illustrated by way of example, as with the first through third exemplary embodiments.

As shown in FIG. 12, the receiver according to the fifth exemplary embodiment comprises includes reception antenna 101, low-noise amplifier (LNA) 102, first down converter 103, first local generator 104, hopping complex filter 108, and baseband processing circuit 114, which have been shown in the first exemplary embodiment, and additionally includes selective filter 1101, variable-gain amplifier 1102, and A/D converters 1103.

The receiver according to the fifth exemplary embodiment employs selective filter 1101 which is capable of changing filter characteristics, connected, instead of the second down converter according to the first exemplary embodiment, to a stage subsequent to hopping complex filter 108. Reception antenna 101, low-noise amplifier (LNA) 102, first down converter 103, second local generator 104, hopping complex filter 108, and baseband processing circuit 114 have the same configuration as those of the receiver according to the first exemplary embodiment, and will not be described below.

When symbol f1 and symbol f3 are received, selective filter 1101 operates as a band-pass filter which allows frequencies from 264 to 792 MHz, for example, to pass therethrough and attenuates other frequencies.

When symbol f2 is received, selective filter 1101 operates as a low-pass filter which allows frequencies up to about 264 MHz, for example, and attenuates other frequencies. The filter characteristics of selective filter 1101 are switched fast in synchronism with the hopping process on the UWB signal according to a control signal output from baseband processing circuit 114, for example.

Variable-gain amplifier 1102 amplifies frequency signals up to 792 MHz wherein symbol f1 through symbol f3 pass, for example, as with the first exemplary embodiment.

A/D converter 1103 according to the present exemplary embodiment performs A/D conversion on frequency signals up to 792 MHz as with variable-gain amplifier 1102. A/D converter 1103 has a conversion rate set to 528 Msps, for example, i.e., has a Nyquist frequency set to 264 MHz.

Usually, the above conversion rate represents a frequency range required to convert only symbol f2 near the DC level. According to the present exemplary embodiment, symbol f1 and symbol f3 are under-sampled at this conversion rate.

According to the present exemplary embodiment, the components up to hopping complex filter 108 operate in the same manner as with the first exemplary embodiment.

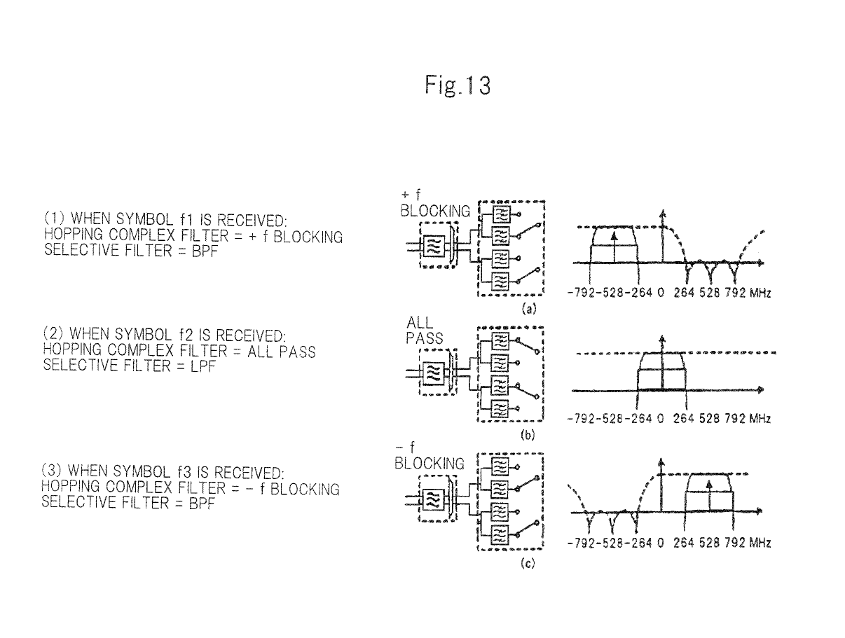

When symbol f1 is received, selective filter 1101 operates as a band-pass filter (BPF) which allows the frequency components of symbol f1 to pass therethrough and suppresses other signals and noise, as shown in FIG. 13(a).

Variable-gain amplifier 1102 amplifies IF signals output from filter 1101 to a required level matching the dynamic range of A/D converter 1103, and outputs the amplified IF signals to A/D converter 1103.

As described above, A/D converter 1103 under-samples symbol f1.

A/D converter 1103 is capable of under-sampling symbol f1 because almost only symbol f1 has been extracted by hopping complex filter 108 and filter 1101.

Similarly, when symbol f2 is received, hopping complex filter 108 switches to the all pass characteristics, and filter 1101 operates as a low-pass filter (LPF) for extracting symbol f2 (see FIG. 13(b)).

Since symbol f2 is present in the Nyquist frequency of A/D converter 1103, it is converted by A/D converter 1103 without problems.

Similarly, when symbol f3 is received, hopping complex filter 108 switches to the −f blocking characteristics, and filter 1101 operates as a band-pass filter (BPF) for extracting symbol f3 (see FIG. 13(c)).

Symbol f3 is present outside of the Nyquist frequency of A/D converter 1103. However, since almost only symbol f3 has been extracted by hopping complex filter 108 and filter 1101, it is converted by A/D converter 1103 without problems.

According to the present exemplary embodiment, inasmuch a minimum conversion rate (528 Msps) required for A/D converter 113 to convert one symbol is enough, the circuit and power consumption of A/D converter 1103 are minimized.

The receiver according to the present exemplary embodiment offers advantages, in addition to the advantages offered by the receivers according to the first through third exemplary embodiments, in that the circuit area and power consumption of the overall receiver are minimized.

According to the first through fifth exemplary embodiments, each band group is illustrated as being made up of three bands. However, each band group is not limited to being made up of three bands. If the frequency of local signals are set to the central frequency of the band groups, then each band group may be made up of any number of bands, whether it may be odd or even, in providing the same advantages as those described above.

For example, if a band group is made up of three (odd number) of bands, then the frequency of local signals may be set to the central frequency of the second band. If a band group is made up of four (even number) of bands, then the frequency of local signals may be set to a frequency between the second band and the third band.

The UWB wireless communication apparatus according to the present invention employs a hopping complex filter for suppressing image signals thereby to minimize the conversion rates of the A/D converter and the D/A converter. Even if the frequency of local signals is somewhat spaced from the central frequency of band groups, insofar as there is a conflict of image signals, the excellent advantages of the present invention are accomplished by filtering the image signals with the hopping complex filter.

This application is based upon and claims the benefit of priority from Japanese patent application No. 2006-305825, filed on Nov. 10, 2006, the disclosure of which is incorporated herein in its entirety by reference.

1. A wireless communication apparatus for performing wireless communications while hopping, according to a predetermined sequence, between a plurality of bands each having a predetermined frequency range and making up a band group for wireless communications, comprising:
a local generator for generating a local signal having a frequency equal to the central frequency of the band group;
a first down converter for down-converting a wireless signal in each of the bands into an IF signal, using the local signal generated by said local generator;
a hopping complex filter for removing an image signal in the frequency range of a band to pass therethrough, among down-converted signals, said hopping complex filter having filter characteristics changeable depending on the hopping between the bands; and
a second down converter for converting an IF signal of a band which does not contain said central frequency, among signals having passed through said hopping complex filter, into a baseband signal in a predetermined frequency range about a DC level.

2. A wireless communication apparatus according to claim 1, wherein said second down converter is implemented by an analog circuit, further comprising:
an A/D converter for converting said baseband signal output from said second down converter into a digital signal, said A/D converter having a conversion rate required for converting a signal frequency range of at least one of said bands.

3. A wireless communication apparatus according to claim 1, wherein said second down converter is implemented by digital signal processing, further comprising:
an A/D converter for converting the signals having passed through said hopping complex filter into a digital signal, said A/D converter having a conversion rate required for converting signal frequency ranges of at least two of said bands.

4. A wireless communication apparatus according to claim 1, wherein said hopping complex filter and said second down converter are implemented by digital signal processing, further comprising:
an A/D converter for converting the down-converted signals into a digital signal, said A/D converter having a conversion rate required for converting signal frequency ranges of at least three of said bands.

5. A wireless communication apparatus according to claim 1, further comprising:
a selective filter, in place of said second down converter, for converting an IF signal of a band which does not contain said central frequency into a baseband signal in a predetermined frequency range about a DC level, said selective filter having filter characteristics changeable depending on the hopping between the bands; and
an A/D converter for converting said baseband signal output from said second down converter into a digital signal, said A/D converter having a conversion rate required for converting a signal frequency range of at least one of said bands.

6. A wireless communication apparatus for performing wireless communications while hopping, according to a predetermined sequence, between a plurality of bands each having a predetermined frequency range and making up a band group for wireless communications, comprising:
a local generator for generating a local signal having a frequency equal to the central frequency of the band group;
a first up converter for up-converting a baseband signal to be transmitted into an IF signal;
a hopping complex filter for removing an image signal in the frequency range of a band to pass therethrough, among up-converted signals, said hopping complex filter having filter characteristics changeable depending on the hopping between the bands; and
a second up converter for converting an IF signal of a band which does not contain said central frequency, among signals having passed through said hopping complex filter, into a signal having a wireless frequency of said band depending the hopping between the bands.

7. A wireless communication apparatus according to claim 6, wherein said first up converter is implemented by digital signal processing, further comprising:
a D/A converter for converting said baseband signal into an analog signal, said D/A converter having a conversion rate required for converting signal frequency ranges of at least two of said bands.
